(19) United States
(12) Patent Application Publication
(10) Pub. No.: US 2016/0033062 A1
(43) Pub. Date: Feb. 4, 2016

(54) Connector Structure Capable of Effectively Preventing Broken Water Pipe from Spraying Water

(71) Applicant: Chin Yuan Huang, Guangdong Province (CN)

(72) Inventor: Chin Yuan Huang, Guangdong Province (CN)

(21) Appl. No.: 14/449,767

(22) Filed: Aug. 1, 2014

(51) Int. Cl. F16L 15/08; F16L 15/00

(52) U.S. Cl. CPC F16L 15/08; F16L 15/00

(57) ABSTRACT

The invention discloses a connector structure capable of effectively preventing a broken water pipe from spraying water. The connector structure comprises a connector body provided with a water hole, wherein one end of the connector body is connected with a water pipe, and the other end of the connector body is sleeved with a nut, and one end of the connector body provided with the nut is connected with a valve body; the valve body comprises an annular ring connected to the connector body, the annular ring is connected with a valve plate through the connecting bars, the valve plate is normally opened to the water hole and can press and seal the water hole of the connector body under a water pressure. The connector structure provided by the invention is capable of effectively preventing the broken water pipe from spraying water, is simple, reasonable and compact in structure, and low in implementation cost.

### TECHNICAL FIELD

The invention relates to a water pipe connector, in particular to a connector structure capable of effectively preventing a broken water pipe from spraying water.

### BACKGROUND OF THE INVENTION

The water pipe connector is used for connecting a water pipe with a water resource (like a faucet), so that people can conveniently use the water pipe to guide water flow. The water pipe connector generally comprises a connector body provided with a water hole, wherein one end of the connector body is connected with the water pipe, and the other end is sleeved with a nut which is connected with the water resource, like the faucet. In use of the water pipe, the environment of the water pipe may be severe, the water pipe may be bent and so on, and the water pipe is easily aged after being used for a long time, so that the water pipe is easily broken. Once the water pipe is broken, and the water resource is not closed in time, the water pipe will spray the water all around, the user is easily splashed, the water resource is wasted and so on, so that the certain inconvenience is caused to a user. But the problem of water spraying cannot be eliminated in the traditional technology after the water pipe is broken. Therefore, the connector structure of the water pipe needs to be improved and optimized.

### SUMMARY

In order to overcome the defects of the prior art, the invention provides a connector structure, which is capable of effectively preventing the broken water pipe from spraying water, and is simple, reasonable and compact in structure.

The technical scheme adopted to solve the technical problems is: a connector structure capable of effectively preventing a broken water pipe from spraying water comprises a connector body provided with a water hole, wherein one end of the connector body is connected with the water pipe, and the other end of the connector body is sleeved with a nut, and one end of the connector body provided with the nut is connected with a valve body; the valve body comprises an annular ring connected to the connector body, the annular ring is connected with a valve plate through connecting bars, the valve plate is normally opened to the water hole and can press and seal the water hole of the connector body under the water pressure.

As the improvement of the technical scheme, the valve plate axially protrudes the annular ring along the annular ring.

As the further improvement of the technical scheme, the valve plate is connected to the annular ring through the three connecting bars, and the three connecting bars are peripherally uniformly distributed at the peripheral side of the valve plate.

Further, an annular bulge is formed by axially extending one end of the connector body, a raised ring is formed by extending one end of the annular bulge in a radial way, a ring slot adaptive to the raised ring is formed in the inner wall of the annular ring, and the annular ring is fixed on the connector body through the engagement connection between the ring slot and the raised ring.

Further, a boss fitting for the valve plate protrudes from the connector body axially, and the water hole penetrates through the boss.

Further, the connector body is provided with a flange which limits the position of the nut.

The invention has the beneficial effects that one end of the connector body provided with the nut is connected with the valve body, the water hole of the connector body can be pressed and sealed by the valve plate of the valve body under a water pressure. When the water pipe is broken, the water pressure at the two sides of the valve plate is not balanced, the water pressure at the end of the valve plate adjacent to the water resource is higher than that of the end adjacent to the broken water pipe, and the valve plate is pressed and engaged tightly onto the water hole of the connector body under the water pressure, so that the water hole can be sealed, the water flow cannot be sprayed from the broken water pipe, the water flow spraying can be controlled well after the water pipe is broken, the sprayed water flow can be prevented to splash to a user or spray to the environment, and the water can be greatly saved simultaneously. The connector structure is simple, reasonable and compact in structure, convenient to mount, simple to implement, low in cost, and can be extensively used for various water pipe connectors.

### BRIEF DESCRIPTION OF THE DRAWINGS

FIG. 1 is a schematic structure view of the invention.

FIG. 2 is a section view of the invention.

FIG. 3 is a section view of the connector body in the invention.

FIG. 4 and FIG. 5 are schematic structure views of the valve body in the invention.

### DETAILED DESCRIPTION OF THE EMBODIMENTS

The connector structure provided by the invention is further described in details by combining the drawings and the embodiments.

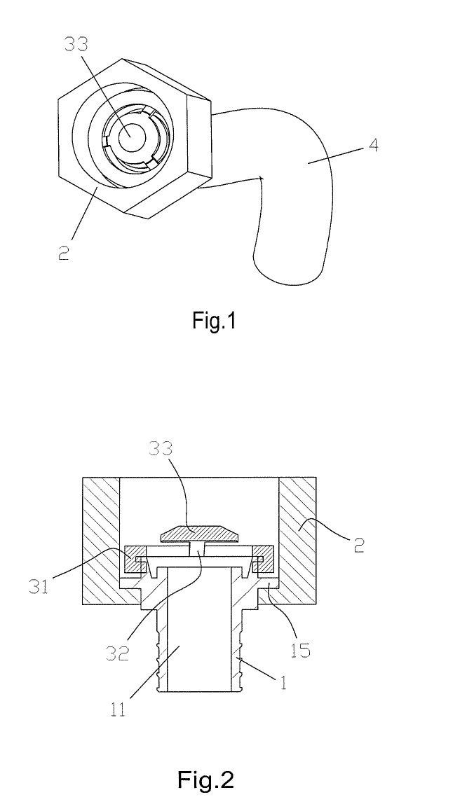

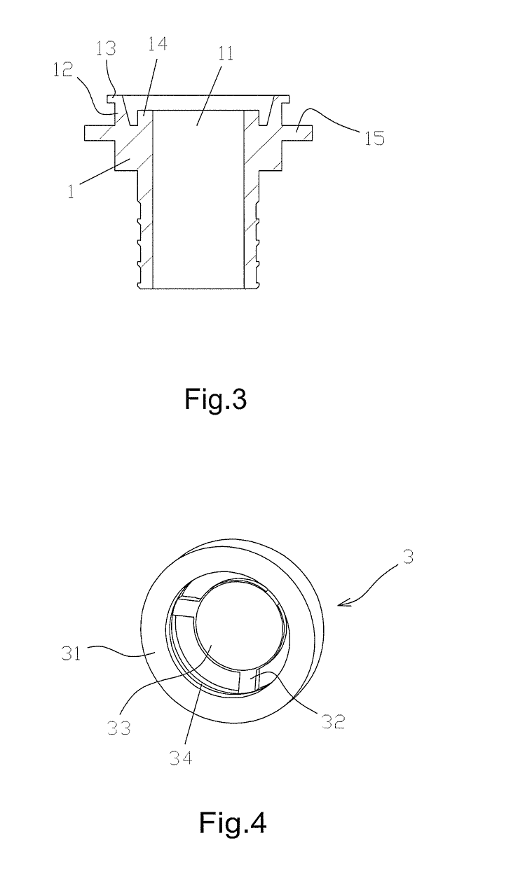

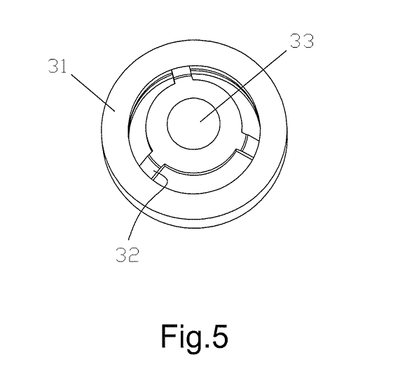

Please refer to FIGS. 1, 2, 3, 4 and 5, a connector structure capable of effectively preventing a broken water pipe from spraying water provided by the invention comprises a connector body 1 provided with a water hole 11, wherein one end of the connector body 1 is connected with a water pipe, and the other end of the connector body 1 is sleeved with a nut 2, and a valve body 3 is arranged on the end of the connector body provided with the nut 2; the valve body 3 comprises an annular ring 31 connected to the connector body 1, and the annular ring 31 is connected with a valve plate 33 through connecting bars 32, and the valve plate is normally opened to the water hole 11. After the water pipe is broken, the water pressure at the two sides of the valve plate 33 is unbalanced, and the water pressure at the end adjacent to the water source is high, so that the water hole 11 of the connector body 1 can be pressed and sealed by the valve plate 33 under the water pressure; and the valve body 3 is optimally made of rubber material.

In the embodiment, preferably, the valve plate 33 protrudes from the annular ring 31 along axial direction of the annular ring 31. The structure is beneficial for the valve plate 33 to be opened to the water hole 11 normally, so that the influence on the normal use of the water pipe can not be caused by the valve plate 33 under the condition that the water pipe is not broken.

In the embodiment, preferably, the valve plate 33 is connected to the annular ring 31 through the three connecting bars 32, and the three connecting bars 32 are peripherally uniformly distributed at the peripheral side of the valve plate 33, so that with the structure, the valve plate 33 can be more reliably and stably connected to the annular ring 31, and can not affect the valve plate 33 to operate normally.

In the embodiment, as for the connection and installation of the annular ring 31, the structure may be adopted: the annular bulge 12 is formed by axially extending one end of the connector body 1, the raised ring 13 is formed by extending one end of the annular bulge in a radial direction, a ring slot 34 adaptive to the raised ring 13 is formed in the inner wall of the annular ring 31 and the annular ring 31 is fixed on the connector body 1 through the engagement connection between the ring slot 34 and the raised ring 13. The connection of structure is reliable and stable, and the valve body 3 can not be easily fallen off from the connector body 1. However, the structure is not limited and other known connecting structures can be adopted.

In the embodiment, preferably, a boss 14 adaptive to the valve plate 33 is formed by protruding from the connector body 1 axially; the water hole 11 penetrates through the boss 14. The valve plate 33, as a role of sealing, can seal the water hole better due to the installation of the boss 14, so that the sealing effect is improved.

In order to prevent the nut 2 from falling off or losing from the connector body 1, a flange 15 which limits the position of the nut 2 is arranged on the connector body 1.

According to foregoing connector structure of the invention, one end of the connector body 1 provided with the nut 2 is connected with the valve body, and the water hole 11 of the connector body 1 can be pressed tightly and sealed by the valve plate 33 of the valve body under water pressure. When the water pipe is broken, the water pressure at the two ends of the valve plate 33 is unbalanced, and the valve plate 33 is pressed onto the water hole 11 of the connector body under the water pressure when the water pressure at the end of the valve plate 33 adjacent to the water resource is higher than that of the end adjacent to the broken water pipe, so that the water hole 11 can be sealed, the water flow cannot be sprayed from the broken water pipe, the water flow spraying can be controlled well after the water pipe is broken, the sprayed water flow can be prevented to be splashed to a user or sprayed to a using environment, and the water can be greatly saved. The connector structure provided by the invention is simple, reasonable and compact in structure, low in cost, convenient to install and simple to implement, so that the above-mentioned connector structure can be extensively applied to various water pipe connectors.

The above stated embodiments are only the better implementation modes and embodiments of the connector structure provided by the invention, but the connector structure is not limited to the embodiments, other embodiments which can reach the technical effect by any same or similar ways shall fall into the protection range of the connector structure provided by the invention.

What is claimed is:

1. A connector structure capable of effectively preventing a broken water pipe from spraying water, comprising a connector body provided with a water hole, wherein one end of the connector body is connected with a water pipe, and the other end of the connector body is sleeved with a nut; characterized in that one end of the connector body provided with the nut is connected with a valve body; the valve body comprises an annular ring connected to the connector body, and the annular ring is connected with a valve plate through connecting bars, the valve plate is normally opened to the water hole and can press and seal the water hole of the connector body under a water pressure.

2. The connector structure capable of effectively preventing the broken water pipe from spraying water according to claim 1, characterized in that the valve plate axially protrudes the annular ring in the axial direction of the annular ring.

3. The connector structure capable of effectively preventing the broken water pipe from spraying water according to claim 1, characterized in that the valve plate is connected to the annular ring through three connecting bars, and the three connecting bars are peripherally uniformly distributed at the peripheral side of the valve plate.

4. The connector structure capable of effectively preventing the broken water pipe from spraying water according to claim 3, characterized in that an annular bulge is formed by axially extending one end of the connector body, a raised ring is formed by extending one end of the annular bulge in a radial direction, a ring slot adaptive to the raised ring is formed in the inner wall of the annular ring, and the annular ring is fixedly connected to the connector body through the engagement connection between the ring slot and the raised ring.

5. The connector structure capable of effectively preventing the broken water pipe from spraying water according to claim 4, characterized in that a boss fitting for the valve plate protrudes from the connector body axially, and the water hole penetrates through the boss.

6. The connector structure capable of effectively preventing the broken water pipe from spraying water according to claim 1, characterized in that the connector body is provided with a flange which limits the position of the nut.
